(19) United States
(12) Patent Application Publication
(10) Pub. No.: US 2003/0087546 A1
(43) Pub. Date: May 8, 2003

(54) Electrical connector with strain relief structure

(75) Inventors: Stephen V.R. Hellriegel, Bainbridge Island, WA (US); Alexander I. Yatskov, Kenmore, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Cray Inc., Seattle, WA (US)

(21) Appl. No.: 10/012,210

(22) Filed: Nov. 5, 2001

(51) Int. Cl. H01R 13/58

(52) U.S. Cl. 439/457

(57) ABSTRACT

An electrical connector, having a flexible substrate and a plurality of contact pads arranged in a regular configuration on a first surface of the substrate. A plurality of electrical traces on the flexible substrate, each in electrical contact with a respective one of the plurality of contact pads is also provided, and a plurality of apertures penetrating through the flexible substrate and arranged in a regular configuration and interlaced into the plurality of contact pads is provided.

### CROSS REFERENCE TO RELATED APPLICATIONS

This application claims the benefit of the U.S. Provisional Patent Application No. ______, filed on Nov. 2, 2001.

### BACKGROUND OF THE INVENTION

1. Field of the Invention

The present invention is related to the field of electrical connectors.

2. Description of the Related Art

Electrical connectors are used in most computer related devices. As manufacturing processes improve, and computer manufacturers achieve ever-increasing circuit densities, the connectors must also have greater densities. A type of connector found in many high performance computers is composed of a flexible substrate on which are formed small contact pads. These connectors are aligned with corresponding circuit contacts on circuit boards in the computers and clamped in place. Many of this type of connectors are made with contact densities exceeding 300 or 400 contacts per square inch. As densities increase, naturally, the contact pads must be formed more and more closely together on the surface of the flexible substrate, and the tolerances become increasingly tight.

A problem with the higher density connectors is that small variations in location and planarity of the circuit contacts can overcome the ability of the flexible connector to compensate for those variations and some of the connections may fail.

### BRIEF SUMMARY OF THE INVENTION

According to an embodiment of the invention, a structure is provided to increase flexibility at selected locations on a flexible connector to ensure correct flexibility in the region of contact pads and still maintain an overall stiffness of the connector at other locations.

According to one embodiment, a device is provided having a flexible substrate and a plurality of contact pads on a first surface of the substrate. A structure to modify the local flexibility is positioned adjacent to one or more contact pads. For example, in one embodiment, a strain relief structure is positioned between two of the plurality of contact pads. The strain relief structure may be an aperture, penetrating through the flexible substrate from the first surface to a second surface.

In another embodiment of the invention, the flexibility variation structure is a localized thinning of the flexible substrate.

Another embodiment of the invention provides an electrical connector, having a flexible substrate and a plurality of contact pads arranged in a regular configuration on a first surface of the substrate. A plurality of electrical traces on the flexible substrate, each in electrical contact with a respective one of the plurality of contact pads is also provided, and a plurality of apertures is further provided, penetrating through the flexible substrate and arranged in a regular configuration and interlaced into the plurality of contact pads.

According to an embodiment of the invention, a method is provided, including forming a plurality of contact pads on a first surface of a flexible substrate, then forming a plurality of electrical traces on the flexible substrate, each of the traces being in contact with one of the plurality of contact pads, and forming a strain relief structure between two of the contact pads.

In another method, according to an embodiment of the invention, one of the electrical traces is broken with the forming the strain relief structure step.

### BRIEF DESCRIPTION OF THE SEVERAL VIEWS OF THE DRAWING(S)

The features and advantages of the present invention will be discussed in detail in the following description, and in conjunction with the accompanying drawings.

FIG. 1 shows a plan view of a flexible connector, according to known art.

FIG. 2 shows an enlarged view of a segment of the connector of FIG. 1.

FIG. 3 shows a cross section view of a section of a circuit board and a flexible connector according to known art.

FIG. 4 shows view similar to that of FIG. 3, of a connector and a flexible connector according to known art.

FIG. 5 shows a section of a flexible connector in plan view, according to an embodiment of the invention.

FIG. 6 shows an enlarged view of a section of the connector of FIG. 5.

FIG. 7 shows a cross section of the connector of FIG. 6, taken at lines VII-VII, according to one embodiment.

FIG. 8 shows a cross section of the connector of FIG. 6, taken at lines VII-VII, according to another embodiment.

FIG. 9 shows a cross section of a circuit board and a flexible connector according to an embodiment of the invention.

FIGS. 10A-10E show in plan view, various configurations of contact pads and strain relief structures according to the invention.

FIGS. 11A-11D show various shapes of strain relief structures according to the invention.

### DETAILED DESCRIPTION OF THE INVENTION

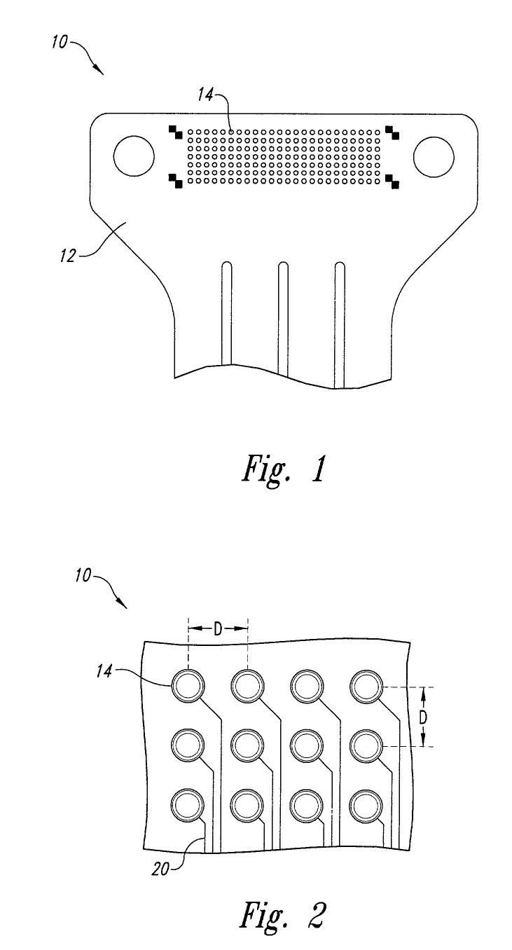

FIGS. 1 and 2 show a flexible connector 10 according to known art. The connector 10 includes a flexible substrate 12, having a plurality of contact pads 14 in a regular configuration. The distances D between contact pads is 0.05 inches in the connector shown, giving it a density of 400 contacts per inch. Electrical traces 20, shown in FIG. 2, in electrical contact with the contact pads, provide electrical coupling with other circuits or connectors, not shown.

Flexible substrates 12 may be composites of commercially available materials. For example, the Dupont Pyralux series is commonly used for the various insulting layers in the substrate 12. The substrate 12 may have multiple layers of the substrate material to accommodate high densities of circuit traces, with the electrical traces 20 being formed on the outer surfaces of the substrate 12 as well sandwiched between internal layers. The flexibility of the connector is affected by the number of layers, the thickness of the layers, the adhesives used to bond multiple layers, the coatings on the surfaces of the connector and the overall dimensions of the connector. The number of layers and stiffness of the substrate is chosen to protect the connector 10 and traces 20 from damage caused by excessive flexing and by abrasion. If many layers are needed, due to the complexity of the circuit of the protection needed, the substrate 12 may be stiffer than desired for the electrical properties.

Flexible connectors are frequently employed to connect a circuit board to another circuit board or a peripheral device. They may be used in applications where densities of contacts are required to exceed 400 contacts per inch. A clamping device, not shown, presses the connector against a circuit board, applying pressure to the back of each contact pad, and pressing them independently against the respective circuit contact on the circuit board. The flexibility of the connector tolerates a limited variation in the planarity of the upper surfaces of the circuit contacts while maintaining appropriate contact and pressure between the contact pads of the flexible connector and those of the circuit board. High densities of contacts 14 can locally stiffen the connector 10 in the region of the contacts, inasmuch as the metallic contact pads 14 are not flexible and, as densities increase, the contact pads 14 cover a larger proportion of the surface of the connector in the immediate region. As the connector density requirements increase, the tolerances required to establish and sustain adequate surface contact and pressure also become tighter. In order to make a dependable and repeatable connection, the contact pads of the connector must be able to conform to the variations present in the corresponding circuit contacts on a circuit board. The associated circuit board manufacturing costs to meet those tolerances may become prohibitive. A substrate that is the correct stiffness for the connector as a whole is too stiff at the local contact pads to permit localized variations, such as differences in contact height, location, etc., to make repeated, reliable connections and disconnections.

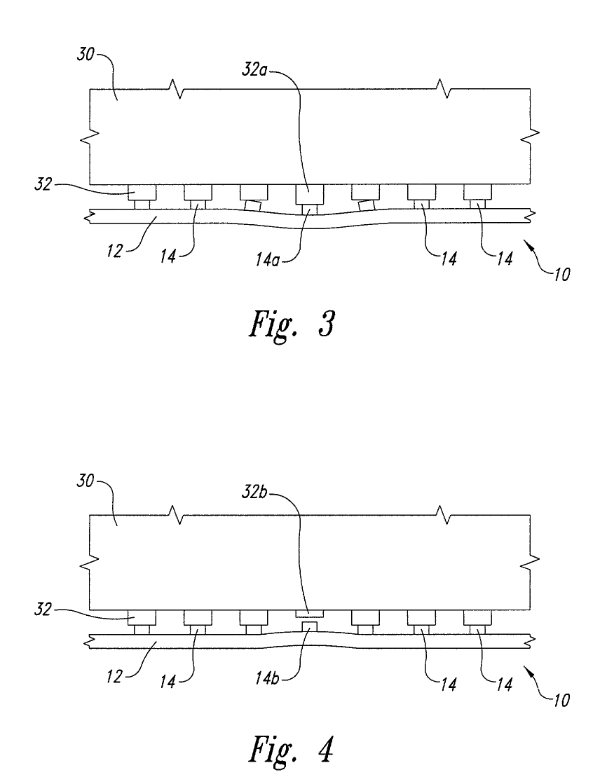

FIGS. 3 and 4 illustrate some types of contact failures that may occur when the variations in contact surface planarity or location exceed the connector's ability to conform. FIG. 3 shows a circuit board 30 with circuit contacts 32. The flexible connector 10, is composed of a flexible substrate 12, having contact pads 14. The contact pads 14 on the flexible connector 10 are required to make contact with the circuit board contact pads 32. In FIG. 3, one of the circuit contacts 32a on the circuit board is taller than those around it. The flexible connector substrate 12 is so stiff that it is not capable of accommodating this variation. As a result, the contact pads 14 closest to the contact pad 14a contacting the taller circuit contact 32a are not able to make complete contact. An incomplete connection of the type shown may result in unpredictable changes in circuit impedance or continuity.

FIG. 4 shows a similar configuration in which a single circuit contact 32b is shorter than the circuit contacts 32 closest to it. The flexible substrate 12 remains stiff, and bridges that contact, so that the corresponding contact pad 14b does not make contact with the circuit contact 32b. If the contact pad 14b has intermittent connections or is not connected at all, data will be lost.

Flexible connectors are designed for use in applications where the connector will be connected and disconnected from the circuit board repeatedly. In many of the situations described in relation to FIGS. 3 and 4, a more powerful clamping force may be applied to cause the connections to make appropriate contact. A drawback of this solution is that the contacts that make connection first, that is, those in contact with the taller circuit contacts 32a will be deformed and damaged over time and repeated use, making them unreliable in long term applications. Excess clamping force may also damage the substrate, forcing it to flex too closely to the contact pads and fracturing the substrate and the underlying traces.

According to the invention, an alternative to the increased costs of meeting the tightening manufacturing tolerances is to increase the local flexibility of the connectors, permitting them to conform to differences in circuit connector heights at greater densities. Conversely, a high density flexible connector of the type used in these applications is desired to have a certain minimum rigidity to protect the metallic circuit traces, which may be formed in several layers of the connector. Excessive flexibility of the entire connector 10 will subject the traces to stresses that may affect impedances or result in circuit failure.

According to the principles of the invention, a flexible connector 10 is provided having a flexibility that varies over the surface of the substrate 12. It has greater flexibility in a localized region surrounding contact pads 14 and greater stiffness over the rest of the connector 10. The greater flexibility may be provided by variations in substrate materials of the connector, or by thinning or removing selected amounts of the substrate 12 of the connector 10 in that region. Another embodiment provides a connector having the appropriate increased flexibility needed for the region of the contact pads with stiffeners added to the connector in other areas by adding material or reinforcement. These and other means of providing variable stiffness to a connector are considered to fall within the scope of the invention.

A solution provided by an embodiment of the invention is to provide localized flexibility by removing some percent of the material at selected strain relief locations. By removal of a known, desired amount of material, a precise local flexibility can be achieved while keeping the strip as a whole very strong and at the correct stiffness.

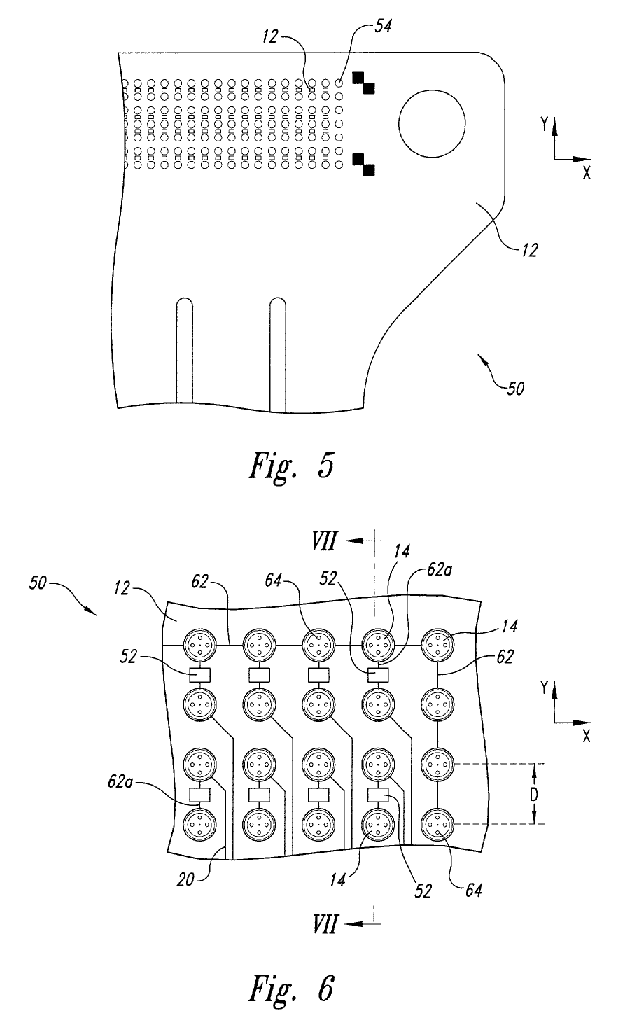

FIGS. 5 and 6 show a flexible connector 50 according to an embodiment of the invention. The connector 50 includes a flexible substrate 12, having a plurality of contact pads 14 in a regular configuration. Strain relief structures 52 are shown between many of the contact pads 54. According to a preferred embodiment, the strain relief structures 52 are apertures that extend completely through the flexible substrate material. Electrical traces 20, shown, in FIG. 6, in electrical contact with the contact pads, provide electrical coupling to other circuits or connectors, not shown. Contact pad traces 62, also known as stringers, electrically connect many of the contact pads to one another. They will be discussed in more detail later in the text.

The connector 50 shown in FIGS. 5 and 6 is configured according to one embodiment of the invention. In the connector 50, shown in FIG. 6, contact pads 14 having micro-pads 64 on their upper surfaces are shown. The micro-pads 64 of FIG. 6 increase the dependability of the connection. A discussion of the advantages of micro-pads may be found in patent application Ser. No. 09/705,368, filed by the applicants on Nov. 3, 2000, incorporated herein by reference.

A compromise between the costs of manufacturing the connectors and the flexibility requirements will influence the configuration of pads 14 and strain relief structures 52. The required added flexibility for the high-density connector 50 of FIGS. 5 and 6 is provided by a limited use of strain relief structures 52. The structures 52 are placed in locations chosen to provide the flexibility required while controlling the manufacturing costs. Other types of connectors, and other applications will require different strain relief configurations.

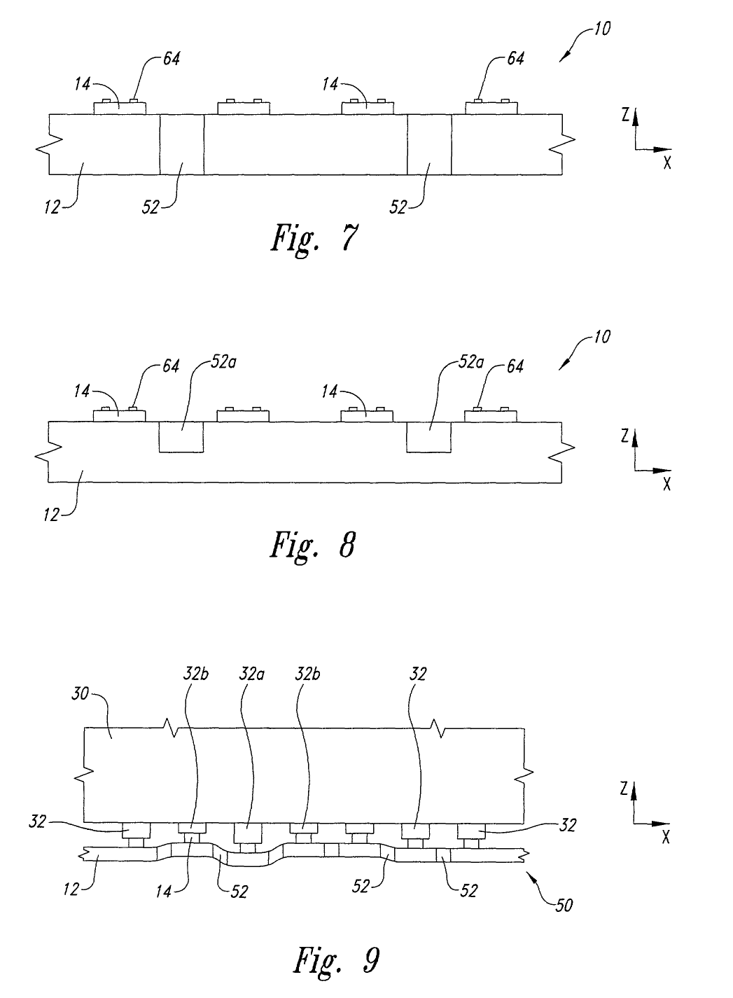

FIGS. 7 and 8 show a cross section of the flexible connector of FIG. 6, taken at lines VII-VII. In FIG. 7 the strain relief structures 52 are shown as apertures that completely traverse, or pass through the substrate material 12. It can also be seen that the structures are placed according to the requirements of the particular application, for a desired flexibility or to cut selected traces 62, and need not be used between each pair of contact pads.

FIG. 8 shows a related embodiment, in which the structures 52a are formed by thinning the substrate material at the desired location. This type of structure may be used in applications where the desired increase in flexibility is less, but the dimensions of the structures are influenced by other needs. Thus, by removing part of the thickness, the change in flexibility is reduced. Another application of this embodiment is in a situation where a gas tight substrate is required. Obviously, the embodiment of FIG. 8 will be more resistant to the passage of gasses through the substrate, than those embodiments in which the structure penetrates the substrate.

The processes used to produce the strain relief structures 52 will vary according to the configuration of the particular embodiment. The structures may be produced via laser cutting and etching, chemical etching, mechanical operations, or any other method that produces the desired result.

FIG. 9 illustrates an embodiment of the invention, and may be compared to FIGS. 3 and 4 to aid in understanding the invention. FIG. 9 shows in cross section a portion of a circuit board 30 with circuit contacts 32. The flexible connector 50 is positioned according to design requirements, the contact pads 14 being positioned opposite respective circuit contacts 32. The contacts 32 vary in height, 32a being taller than the desired height and contacts 32b being shorter than the desired height. In contrast to the situation illustrated in FIGS. 3 and 4, the connector according to the invention is able to conform to the variations in the circuit contacts 32, by virtue of presence of the strain relief structures 52. A clamping device, (not shown) known to the art, is provided, which applies pressure individually on the connector opposite each of the contact pads. The localized flexibility provided by the structures 52 allows the connector to flex more radically between the contact pads 14 and to place each contact pad 14 in correct position on the circuit contacts 32.

FIG. 9 shows a circuit board 30 with circuit contacts 32, and a flexible connector 70 according to an embodiment of the invention. The strain relief structures 52 provide increased flexibility in localized regions, allowing the connector substrate 12 to conform to irregularities in the underlying circuit board 30 in a z axis, without compromising the dimensional stability of the substrate in the x and y axes. The apertures 52 are of a type and in the location shown in FIG. 10F.

A further advantage provided by some embodiments of the invention is a simplified manufacturing method. There are several plating steps during the manufacturing process of flexible connectors. A known practice is to create an electrical trace or connection, also known as a stringer, that is coupled to a common voltage supply, coupling all the contact pads, to a common voltage level to facilitate the plating steps. This assures that the plating will be consistent throughout the connector, and from one contact pad 14 to another. After the last plating step, the stringers are cut to isolate the individual contact pads. The most frequently used technique is to place a common ground line outside the perimeter of the finished part and run separate stringers from each pad to this ground line off the connector 50. When the part is cut from the parent sheet, all the stringers are cut at the same time. A problem with this technique is that the density of the connector is affected, since the pads must be spaced apart sufficiently to accommodate the plating stringers for each pad 14 as well as the electrical traces 62 that must remain intact in the connector.

FIG. 6 shows a section of a connector 50 according to an embodiment of the invention. The contact pads 14 are shown to have been formed with stringers 62 connecting them together to facilitate the plating steps of the manufacturing process. After the final plating step, the strain relief structures 52 are formed, cutting the stringers 62a between the interior contact pads and those on the perimeter. At the perimeter of the group, contacts are shown to have uncut stringers 62 between them. In the embodiment of FIGS. 5 and 6, all the contacts 14 on the perimeter comprise grounding contacts, or voltage supply contacts and thus many are coupled to a common voltage when the part is in operation. The pads 14 are therefore left connected together by the stringers 62. In other embodiments, those perimeter contact pads may be isolated from one another by the same method.

Local flexibility of each contact pad 14, as well as tension and stress are affected by the shape, size and position of the strain relief structure 52. The shape and location of the apertures 52 is selected to focus the flexibility and support at the correct locations on the substrate 12. It is desired to ensure that focus of support be correct for each contact pad 14 at its localized area. In one embodiment, as shown in FIG. 5 the apertures 52 are rectangles that have been cut using a small laser cutting beam. The shape and location of the rectangular apertures 52 provides a focus of support on the individual contact pads 14 while also decoupling respective pads 14 from each other. Significant material is left around the pads 14 to provide strong support while the shape and location of apertures 52 provide the local flexibility to decouple closely adjacent pads 14 from each other. In this embodiment, the decoupling apertures 52 are in between every other row rather than every row and are small relative to the contact pads 14 and the area left in the substrate 12. Thus there is a very small increase in local flexibility for such an arrangement.

FIGS. 10A-10E illustrate some of the possible configurations that might be used in other applications.

FIG. 10A shows a configuration in which the strain relief structures 52 are configured as ovals and aligned with the contact pads 12 in vertical rows. This configuration allows a maximum area between the vertical rows to accommodate circuit traces.

FIG. 10B is similar to 10A, the oval structures 52 having been configured horizontally to provide additional clearance horizontally.

FIG. 10C shows curved structures 52 which significantly increase the decoupling of the contact pads from the body of the connector. The position of the structures, and their proximity to the contact pads will affect the degree of decoupling or isolation. The configuration of FIG. 10C still has adequate space for circuit traces to connect to the contact pads.

FIG. 10D shows a maximum degree of decoupling, leaving a minimum of connection between the contact pads 14 and the body of the connector. This configuration might be used in an embodiment where the strain relief structure is formed by a thinning of the substrate, like that illustrated in FIG. 8. In such an application, the circuit traces may be formed in a lower layer and pass underneath the structure.

FIG. 10E shows the structures 52 in a diagonal configuration. This position of apertures 52 will focus the support from row to row and tend to provide equal decoupling in the x as well y direction. Of course, any other orientation may be used to achieve the desired focus of support and orientation of decoupling.

FIG. 10F shows relatively small strain relief structures 52 aligned in the spaces between the contact pads both horizontally and vertically. This will provide decoupling at pads 14 in the same row from each other, as well as in adjacent rows. Of this will be desired in many applications. Alternatively, the apertures 52 between rows will not be present and only apertures 52 between pads 14 in the same row will be used. This will provide a focus of support as desired. As can be seen, the location, size, slope an/or configuration of apertures 52 can be selected to provide the desired focus of support while at the same time adding the desired decoupling to provide the correct amount of local flexibility.

Those skilled in the art will recognize many other useful configurations beyond those illustrated or described here. Such other configurations, too, are within the scope of the invention.

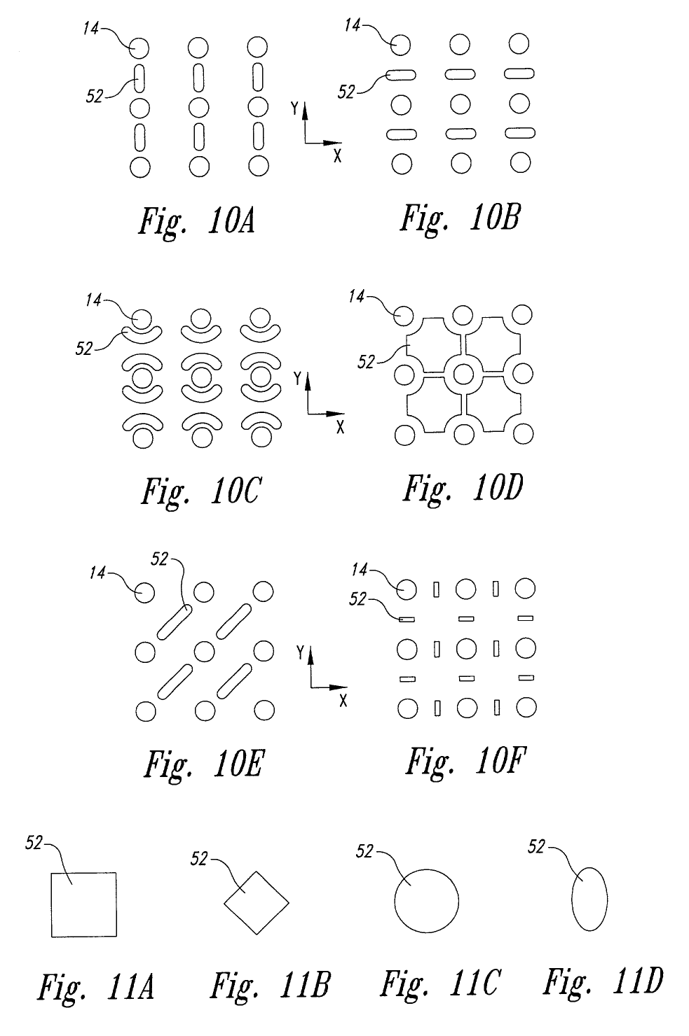

FIGS. 11A-11D show some of the possible shapes that might be chosen for the strain relief structures 52. These and other variations in the size, shape and configuration of the strain relief structures according to the requirements of specific applications will be obvious to those skilled in the art, and are considered to fall within the scope of the invention.

An aperture 52 with sharp corners will tend to concentrate stress in those corners, which may cause them to crack or break over time and repeated flexing. A rounded corner, on the other hand, will distribute the strain over a larger area. The parameters of the structures may also be chosen to direct stress in lines parallel to the rows of contact pads, or across them, according to the design criteria of the particular application.

Finally, it is apparent that many modifications and variations can be made to the device and methods described and illustrated here, all of which come within the scope of the inventive concept, as defined in the attached claims.

1. A device, comprising:
a flexible substrate;
a plurality of contact pads on a first surface of the substrate; and
a strain relief structure, positioned between two of the plurality of contact pads.

2. The device of claim 1 wherein the strain relief structure is an aperture, penetrating through the flexible substrate from the first surface to a second surface.

3. The device of claim 2 wherein the aperture has, in plan view, a rectangular shape.

4. The device of claim 1, wherein the strain relief structure is a thinned region of the flexible substrate.

5. The device of claim 4, wherein the thinned region has, in plan view, a rectangular shape.

6. The device of claim 1, wherein the strain relief structure is centered on a line between centers of two of the plurality of contact pads.

7. The device of claim 1, further comprising a plurality of electrical traces, each of the plurality of electrical traces being in electrical contact with one of the plurality of contact pads.

8. The device of claim 7, wherein the strain relief structure is positioned such that it interrupts one of the plurality of electrical traces.

9. An electrical connector, comprising:
a flexible substrate;
a plurality of contact pads arranged in a regular configuration on a first surface of the substrate;
a plurality of electrical traces on the flexible substrate, each of the plurality of electrical traces being in electrical contact with a respective one of the plurality of contact pads; and
a plurality of apertures penetrating through the flexible substrate, the plurality of apertures arranged in a regular configuration and intercalated into the plurality of contact pads.

10. A method, comprising:
forming, on a first surface of a flexible substrate, a plurality of contact pads;
forming, on the flexible substrate, a plurality of electrical traces, each of the plurality of electrical traces being in contact with one of the plurality of contact pads; and
forming, between two of the plurality of contact pads, a strain relief structure.

11. The method of claim 10, further including breaking one of the electrical traces with the forming the strain relief structure step.

12. The method of claim 10 wherein the strain relief structure is an aperture penetrating the flexible substrate from the first surface to a second surface.

13. The method of claim 10, wherein each of the plurality of electrical traces is formed on either the first surface of the flexible substrate, a second surface of the substrate or an inner layer of the substrate.
